(19) United States
(12) Patent Application Publication
(10) Pub. No.: US 2004/0037954 A1
(43) Pub. Date: Feb. 26, 2004

(54) Process and device for cold gas spraying

(75) Inventors: Peter Heinrich, Germering (DE); Heinrich Kreye, Hamburg (DE); Erich Muehlberger, San Clemente, CA (US)

Correspondence Address: MILLEN, WHITE, ZELANO & BRANIGAN, P.C., 2200 CLARENDON BLVD., SUITE 1400, ARLINGTON, VA, 22201, US

(73) Assignee: LINDE AKTIENGESELLSCHAFT, Wiesbaden (DE)

(21) Appl. No.: 10/453,872

(22) Filed: Jun. 4, 2003

(30) Foreign Application Priority Data
Jun. 4, 2002 (DE) 102 24 780.3

(51) Int. Cl. B05D 1/12

(52) U.S. Cl. 427/180; 118/326; 118/308; 427/421

(57) ABSTRACT

According to the invention, the cold gas spraying process is carried out in a vacuum chamber at a pressure that is below 800 mbar (80 kPa). To do this, the cold gas spray gun (3) and the work piece (5) are located in a vacuum chamber (4). This enables use of optimally acting carrier gases such as, for example, helium or helium-containing mixtures.

### CROSS-REFERENCE TO RELATED APPLICATION

This application is related to concurrently filed, commonly assigned application attorney docket no. LINDE-609, entitled “Process and Device for Cold Gas Spraying”, which corresponds to German priority 10224777.3, the inventors being Peter Heinrich, Heinrich Kreye and Werner Krömmer.

The invention relates to a process for producing a coating on a work piece or a molding in a cold gas spraying process, a carrier gas and powdered spray particles being released in a cold gas spray gun and the spray particles being brought to a speed sufficient to carry the particles, such as a speed of up to 2000 m/s.

It is known that coatings can be applied to materials of the most varied type by thermal spraying. Known processes for this purpose are, for example, flame spraying, arc spraying, plasma spraying or high-speed flame spraying. Recently, a process was developed, so-called cold gas spraying, in which the spray particles are accelerated to high speeds in a cold gas spray gun in a “cold” gas jet. The coating is formed by the impact of the particles with high kinetic energy on the work piece. Upon impact, the particles that do not melt in the “cold” gas jet form a dense and tightly adhering layer, plastic deformation and the resulting local release of heat providing for cohesion and adhesion of the spray layer to the work piece. Heating up the carrier gas jet heats the particles for better plastic deformation upon impact, and increases the gas flow velocity and thus also the particle speed. The associated gas temperature can be up to 800° C., but is distinctly below the melting point of the coating material, so that melting of the particles in the gas jet does not occur. Oxidation and/or phase transformations of the coating material can thus be largely avoided. The spray particles are added as powder by delivering the particles with an auxiliary gas flow to the main gas flow. The powder thus ordinarily comprises particles with a size from 1 to 50 μm. The spray particles acquire high kinetic energy as the gas is expanded. Generally, the gas after injection of the spray particles into the main gas jet is expanded in a nozzle. The carrier gas and the spray particles are accelerated to speeds exceeding the speed of sound. Thus, for the particle, e.g., metal, a minimum velocity is utilized, for example, a velocity of 500-600 meters per second for copper. With low velocities, the copper can trickle down while higher velocities can result in copper sticking to the nozzle surface. Desirably, velocity should not only be sufficient to carry the particles but sufficient to bring the particles over the critical temperature when striking and deforming on the target. Injection of the spray particles into the already accelerated main gas jet, however, is also practiced. One such process and a device for cold gas spraying are described in particular in European Patent EP 0 484 533 B1.

The carrier gases are generally nitrogen, helium and nitrogen-helium mixtures. The same gas or different gases can be used for the main and auxiliary gas flow. Nitrogen, the most frequently used carrier gas, is well suited as an inert and economical gas for the cold gas spraying process. Conversely, air, in spite of its high nitrogen content, is feasible only for a few applications due to the oxygen content. The highest particle speeds are generally reached with helium as the carrier gas. Because very large amounts of carrier gas are needed, however, generally in practice only nitrogen-helium mixtures with a low proportion of helium are used.

Economic considerations are decisive in the choice of the carrier gas due to extremely high carrier gas consumption. The consumption of carrier gas in cold gas spraying is between 40 and 150 m³/h. The gas consumption depends on the carrier gas used for the main and auxiliary gas flow and the material of the spray particles. Generally, the range of volume of gas flow and volume of particles is roughly one per thousand of particles by volume or some percent of particles measured by weight. Also, the acceleration of the particles is proportional to the gas density and indirectly proportional to the particle density. Generally, the smallest cross-section of the nozzle is 2.7 mm because 1 cubic meter per minute of nitrogen is required for supersonic velocity. Tests with helium as the carrier gas have shown that in order to spray 3 kg of spray material MCrAlY), where M is metal such as nickel, cobalt, or both, Cr is chromium, Al is aluminum, and Y is yttrium, a bundle of 110 m³ of helium is necessary. In the choice of the carrier gas, consequently, economic aspects can be of priority importance; often they do not allow use of carrier gases that are optimum in terms of process engineering.

Therefore, a feature of this invention is to devise a process that allows the choice of a carrier gas for the main and auxiliary gas flow that is optimum for the cold gas spraying process and improves the process of cold gas spraying.

This feature can be achieved according to the invention in that the cold gas spraying process is carried out at low pressure at values below 800 mbar (80 kPa). To do this, the cold gas spray gun and the work piece to be coated or the molding are placed in a vacuum chamber. Because the cold gas spray gun and the sprayed article are located in a vacuum chamber, the entire spraying process takes place under vacuum conditions. This drastically reduces the consumption of carrier gas. This thus makes it possible to select the carrier gas according to its properties and not according to its economical availability. The spray particle speed that is achieved with the process according to the invention is also distinctly above the spray particle speed that is achieved with a similar arrangement under normal conditions. The results in cold gas spraying are of high quality due to the high spray particle speed. The cold gas spraying under vacuum conditions according to the invention almost eliminates the air resistance that slows down the spray particles after emerging from the cold gas spray gun until reaching the sprayed article. The high spray particle speed that prevails when emerging from the spray gun is maintained until impact on the work piece occurs. As a result of the high particle speed, in turn, the kinetic energy of the particles is higher and their plastic deformation upon impact is more dramatic. This yields very dense and adhesive layers. Also, the distance of the sprayed article from the spray gun can be chosen to be greater than under atmospheric pressure, because the spray particles are not slowed down by the air resistance on this route. This has the advantage that all geometries on moldings and work pieces can be coated. In addition, the cold gas spraying process under vacuum conditions also allows the use of a wide spray jet. The preservation of the high particle speeds at low pressure as far as the work piece is especially pronounced when the work piece and spray gun are distanced by more than 60 mm. This can be attributed to the fact that the particle speed directly after leaving the spray gun is still increasing before braking by the ambient air makes itself noticeable. If the spray distance exceeds 60 mm, the advantages of the low pressure and the associated absence of braking become apparent. Spray distances of more than 60 mm are advantageous when large work pieces or very many work pieces are being coated, because on the longer path to the work piece, the spray jet fans out farther and the fanned-out jet enables coating of a larger area compared to the focused jet. Furthermore, when the spray distance is chosen to be this great, work pieces with uneven surfaces, in which the distance between the spray gun and work piece surface greatly varies locally, can be coated without problems.

In an advantageous embodiment of the invention, the cold gas spraying process is carried out at a pressure of between 1 and 500 mbar (0.1 to 50 kPa), preferably 20 to 100 mbar (2 to 10 kPa). At this low pressure, the aforementioned advantages of cold gas spraying under vacuum conditions arise. This pressure range is easily achieved with commercial vacuum pumps.

Some of the parameters, e.g., temperature, of the present invention can be disclosed in the Stolrenhoff, et. al., “An Analysis of the Cold Spray Process and Its Coatings”, Volume 11 (4). Journal of Thermal Spray Technology. December, 2002.

Consequently, an advantage of the present invention is that low pressure in the spray gun can be used to accelerate particles because the backpressure is at a vacuum, rather than atmospheric pressure. As an example, 40 bars of pressure is used to accelerate particles to 2000 m/s against ambient air (1 bar pressure). While to accelerate particles to 2000 m/s, only 20 bar pressure in the spray gun against 500 millibar, or only 0.4 bar pressure in the spray gun against 100 millibar is required. Thus, either machines handling low pressure or machines handing high pressure to obtain very high accelerations can be used.

With respect to temperatures, generally temperatures lower than the melting point of the metal, but are as high as economically possible without baking the nozzle surface are desired. As an example, nickel has a melting point of 1550° C., so temperatures significantly lower than 1550° C. are desired for nickel, prefer a temperature before the first effects of melting occur. So for nickel, a temperature of about 0.5 to 0.6 of the Kelvin melting temperature is advantageous, e.g. 880° Kelvin (630° C.) because the particles remain un-molten in the gas stream. When the particles impact the target, the temperature of the particles' surfaces rise and stick to the targeted articles. Generally, higher temperatures of the gas permit higher nozzle velocities permitting better particle acceleration.

Temperatures can also vary depending on the gas used. As an example, helium allows operating at higher velocities and temperature as compared to nitrogen because there is less adhering of the particles to the nozzle surface.

Generally, the velocity of gas must be sufficiently high so that the particles are heated and when striking the target, they stick and not fall down. Exemplary temperatures are 580° C. for copper, 680° C. for aluminum, 600° C. for tantalum, and 800° C. for MCrAlY. With nitrogen as the carrier gas, particles can be accelerated to 1200 m/s, and in some instances, it may be difficult to propel particles at sufficient speeds so they reach the adhering temperature upon impact.

The process according to the invention can be carried out in principle with all gases and gas mixtures as well as with air. Possibly, hydrogen may be used. Especially suitable gases are the rare gases, noble gases, and inert gases and their mixtures. In particular, helium, argon and nitrogen and mixtures of these gases are used, with helium alone or in admixture being especially advantageous as the carrier gas since very high particle speeds are reached with such helium gases. High spray particle speeds guarantee dense and adhesive coatings and thus high quality results in cold gas spraying.

Two separate gases are preferably used in the process of the present invention. One gas is the process gas that imparts the high velocity and the other is the powder feed gas. Which drives the powder into the process gas, and can be another gas or part of the process gas. After powder is in the gas, it is the carrier gas. As an example, 10% of the gas as powder feeding gas can be cold and 90% of the gas as can be hot by acceleration of particles to the required velocity, e.g., up to 2000 m/s, and critical temperature when sticky.

Especially advantageously, the carrier gas contains at least 20% by volume of helium, preferably between 30 and 80% by volume. These helium proportions ensure high spray particle speeds. Mixtures of helium and nitrogen and of helium and argon have proven especially advantageous. Argon-nitrogen mixtures, can also be used.

In an advantageous further development of the invention, it becomes possible to use spray particles with a grain size of up to 150 μm.

To date, conventional spray particles have had grain sizes in the range from 5 to 25 μm, partially also up to 50 μm, and they are generally accelerated in air or nitrogen. Generally, small particles range up to 25 mm. If particles are too small, they cannot stick but rather deflect with the gas. The portion of particles less than 5 mm should be less than 5% by weight of the total particles.

With the process according to the invention, it now becomes possible to also use helium or helium-containing gas mixtures as the carrier gas to a greater extent. With helium, much higher particle speeds are attained, by which larger spray particles with a grain size in the range from 80 to 150 μm are also accelerated relatively strongly, so that they adhere well to the work piece. Alternatively, particles 10-45 μm can also be used. Generally particles 40-90 μm are cheaper to use than smaller particles. Larger spray particles in turn have the advantage over smaller spray particles in that they cake less easily in the nozzle of the spray gun and clog it less. Because larger spray particles compared to smaller spray particles are much more economical, the economic efficiency of the process according to the invention increases.

In a further development of the invention, the carrier gas after the cold gas spraying process is supplied to a recovery unit (9). The recovery unit (9) removes from the carrier gas the impurities that have entered the carrier gas during cold gas spraying and during delivery and discharge. For this purpose, the used carrier gas is removed from the vacuum chamber with a vacuum pump to which a particle filter is connected upstream and is supplied to the recovery unit (9). The recovery unit (9) removes impurities from the used carrier gas and optionally separates individual gas components. In particular, the recovery of helium is economically very advantageous, and it also enables helium to be used as the carrier gas. The cleaned carrier gas or the recovered gas component is now either collected in a tank and supplied to some other application, or after storage in an intermediate tank, is returned to the cold gas spraying device.

One feature achieved with respect to the device is that the cold gas spray gun (3) and the work piece/molding (5) to be coated are located in a vacuum chamber (4). Alternatively, the spray gun (3) can be positioned partially outside the vacuum chamber, i.e., its outlet can be in the chamber and the particle/carrier gas inlets are outside the chamber. This arrangement enables cold gas spraying under vacuum conditions with all its aforementioned advantages.

The invention and other details of the invention are described in more detail below using an embodiment shown in the drawing.

### BRIEF DESCRIPTION OF THE DRAWINGS

FIG. 1 shows a device according to the invention for cold gas spraying under vacuum conditions.

FIG. 1 comprises a cold gas spray gun 3, a vacuum chamber 4, a work piece 5, feed lines 1, 2, and 6, a particle filter 7, and a vacuum pump 8. The main gas flow, for example a helium-nitrogen mixture with 40% by volume of helium, travels via the gas feed line 1, and the spray particles in the auxiliary gas flow travel via the feed line 2 into the vacuum chamber 4, where a pressure of 40 mbar prevails, and there into the cold gas spray gun 3. The feed lines 1 and 2 are routed for this purpose into the vacuum chamber 4 in which both the cold gas spray gun 3 and also the work piece 5 are located. The entire cold gas spraying process thus takes place in the vacuum chamber 4. The carrier gas, which sprays out of the spray gun 3 in cold gas spraying together with the spray particles, carries the spray particles to the work piece and travels into the vacuum chamber 4 after the cold gas spraying process. The used carrier gas is removed from the vacuum chamber 4 by means of the vacuum pump 8 via the gas line 6. Between the vacuum pump 8 and the vacuum chamber 4, the particle filter 7 is connected and removes free spray particles from the used carrier gas so that solid particles do not damage the pump. Generally, the particle filter 7 corresponds to the size of the particles. Alternatively two filters can be used, namely one to clean the gas and the other to hold back the particles. If the filter is too small, it would be blocked by the larger particles.

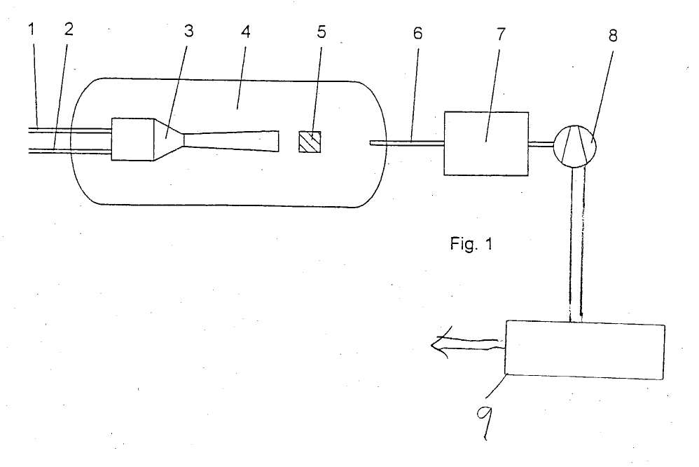

Without further elaboration, it is believed that one skilled in the art can, using the preceding description, utilize the present invention to the fullest extent. The preceding preferred specific embodiments are, therefore, to be construed as merely illustrative, and not limitative of the remainder of the disclosure in any way whatsoever.

In the foregoing and in examples, all temperatures are set forth uncorrected in degrees Celsius and, all parts and percentages are by weight, unless otherwise indicated.

The entire disclosure of all applications, patents and publications, cited herein and of corresponding German Application No. 10224780.3, filed on Jun. 4, 2002 are incorporated by reference herein.

From the forgoing description, one skilled in the art can easily ascertain the essential characteristics of this invention from the spirit and scope thereof, can make various changes and modifications of the invention to adapt it to various usages and conditions.

In the claims:

1. A process comprising producing a coating on a work piece or a molding by a cold gas spraying process, a carrier gas being released in a cold gas spray gun and in doing so the spray particles being accelerated to a velocity sufficient to raise the temperature of the particles so that said particles adhere to the work piece/molding, characterized in that the cold gas spraying process is carried out at low pressure at values below 800 mbar (80 kPa).

2. A process according to claim 1, wherein the cold gas spraying process is carried out at a pressure of between 1 and 500 mbar (0.1 to 50 kPa).

3. A process according to claim 1, wherein carrier gas is 50-100% helium.

4. A process according to claim 1, wherein in the carrier gas, at least 20% by volume of helium is contained.

5. A process according to claim 1, wherein spray particles with a grain size of up to 150 μm are used.

6. A process according to claim 1, wherein the carrier gas after the cold gas spraying process is delivered to a recovery unit.

7. A device for producing a cold gas spray coating on a work piece or a molding comprising a cold gas spray gun (3) and a work piece holder for the work piece/molding (5) to be coated, wherein the cold gas spray gun (3) and the work piece/molding (5) to be coated are located in a vacuum chamber (4).

8. A process for spraying a coating on a object, comprising spraying a carrier gas and particles from a cold gas spray gun at a pressure below 80 kPa.

9. A process according to claim 8, wherein the object is a work piece or a molding.

10. A process according to claim 8, wherein the pressure is 20-100 mbar (2-10 kPa).

11. A process according to claim 8, wherein the carrier gas comprises 30-80% by volume of helium.

12. An apparatus for spray coating an object comprising:
a vacuum chamber for housing the object; and
a cold gas spray gun for spraying a carrier gas and particles to coat the object.

13. An apparatus according to claim 12, further comprising:
a particle filter located downstream from the vacuum chamber for filtering a fluid stream entraining particles exiting the vacuum chamber; and
a vacuum pump located downstream of the particle filter.

14. An apparatus according to claim 13, further comprising:
a recovery unit located downstream of the vacuum pump to recover gases from the pump, and optionally separating the gases and recycling at least a portion to the cold gas spray gun.

15. A process according to claim 8, wherein a velocity of the carrier gas exiting the cold spray gas gun is sufficient to carry the particles.

16. A process according to claim 1, wherein said velocity is up to 2000 m/sec.

17. A process according to claim 15, wherein said velocity is up to 2000 m/sec.
